(19) United States
(12) Patent Application Publication
(10) Pub. No.: US 2026/0009595 A1
(43) Pub. Date: Jan. 8, 2026

(54) COMPOSITE THERMAL MEMBER AND METHOD FOR FORMING SAME

(71) Applicant: 1414 Degrees Limited, Melrose Park, South Australia (AU)

(72) Inventors: Nathan Levinson, Melrose Park, South Australia (AU); Jordan Parham, Melrose Park, South Australia (AU); Mahesh Venkataraman, Melrose Park, South Australia (AU); Pan Vrettos, Melrose Park, South Australia (AU)

(21) Appl. No.: 18/707,476

(22) PCT Filed: Nov. 4, 2022
(86) PCT No.: PCT/AU2022/051323

§ 371 Date: May 3, 2024

(30) Foreign Application Priority Data
Nov. 5, 2021 (AU) 2021903544

(51) Int. Cl. F28D 20/02; C04B 14/32; C04B 14/34; C04B 22/00; C04B 28/06; C04B 40/00; C04B 103/00; C04B 111/00; C09K 5/06

(52) U.S. Cl. CPC F28D 20/023; C04B 14/324; C04B 14/34; C04B 22/0093; C04B 28/06; C04B 40/0082; C09K 5/063; C04B 2103/0071; C04B 2111/00431

(57) ABSTRACT

A composite thermal member for storing thermal energy is disclosed. The composite thermal member comprises a refractory material, a binder material, a thermal energy storage material and a glassy outer protective layer. Also disclosed is a method of forming a composite thermal member for storing thermal energy.

### PRIORITY DOCUMENTS

The present application claims priority from Australian Provisional Patent Application No. 2021903544 titled “COMPOSITE THERMAL MEMBER AND METHOD FOR FORMING SAME” and filed on 5 Nov. 2021, the content of which is hereby incorporated by reference in its entirety.

### TECHNICAL FIELD

The present disclosure relates to thermal energy storage and retrieval. In a particular form, the present disclosure relates to a composite thermal member for storing thermal energy.

### BACKGROUND

High temperature thermal energy storage materials, such as silicon based materials, may be used in thermal energy storage and retrieval applications where a thermal energy storage material is heated in a thermal energy storage mode until it undergoes a phase change to become a liquid; and then in a thermal energy retrieval mode the thermal energy storage material cools and solidifies allowing for retrieval of the stored heat. As these can be high temperature processes occurring at temperatures of circa 1000° C. (and higher) there are a number of engineering and design issues associated with implementing a practical thermal energy storage and retrieval system.

One primary issue is effectively containing the thermal energy storage material. Various refractory materials are known that can contain the thermal energy storage material at these elevated temperatures but the difference between the thermal expansion coefficients of the container material and the thermal energy storage material results in the container being subject to significant structural stresses arising from the expansion and contraction of the thermal energy storage material during heating and cooling cycles (i.e. the thermal energy storage mode and the thermal energy retrieval mode). In the example where the thermal energy storage material is a phase change material consisting of a silicon metalloid, the phase change material expands upon solidification which can result in the container being subject to even more significant structural stresses.

As such, cycling through heating and cooling cycles with known containment arrangements can result in fracture and failure of the container. This not only leads to expensive downtime but also presents a safety issue with the potential for leakage of the molten thermal energy storage material. This can also then restrict the allowable geometries available for the design of the containment arrangement which may compromise the heat transfer capabilities of the system.

Another important engineering constraint that arises in managing thermal energy storage materials and attempting to effectively contain them at high temperatures is the increased chemical reactivity at these higher temperatures. Thermal energy storage materials such as silicon-based materials will oxidise in air degrading their performance and they can also react with the refractory material of the container, as a result compromising the container. Additionally, metals will oxidise at high temperatures making them unsuitable for any type of containment arrangement. Similar issues are typically experienced when carbon-based refractory materials, such as compressed graphite, are used.

As a result, the thermal energy storage material must be maintained in an evacuated or inert gas environment. This also adds another layer of complexity and expense to these types of containment arrangements as any chemical reaction involving the thermal energy storage material or the container material, such as oxidation, can significantly degrade the thermophysical properties and heat transfer performance of the thermal energy storage and retrieval system.

In view of the above considerations, there is a need for alternative options for thermal energy storage material containment arrangements for thermal energy storage and retrieval systems.

### SUMMARY

In a first aspect, the present disclosure provides a composite thermal member for storing thermal energy comprising a refractory material, a binder material, a thermal energy storage material and an outer protective layer.

In another form, the refractory material comprises silicon carbide.

In another form, the silicon carbide forms cement bonded silicon carbide, nitride-bonded silicon carbide, silicon-oxy-nitride bonded silicon carbide, clay bonded silicon carbide, sialon bonded silicon carbide or β-SiC bonded silicon carbide in the composite thermal member.

In another form, the binder material is a cement material.

In another form, the cement material is calcium aluminate cement.

In another form, the outer protective layer is a glassy outer protective layer.

In another form, the glassy outer protective layer is formed from an alkali material selected from one or more of the group consisting of calcium aluminate, calcium carbonate, magnesium carbonate, sodium carbonate, calcium oxide, magnesium oxide, aluminium oxide, boron trioxide, alumina, sodium silicate or potassium silicate.

In another form, the outer protective layer is formed from calcium aluminate.

In another form, the thermal energy storage material is a phase change material.

In another form, the phase change material is a silicon based eutectic material.

In another form, the phase change material is aluminium-silicon-nickel (Al—Si—Ni) eutectic.

In another form, the thermal energy storage material is in particulate or granular form having a predetermined size range.

In another form, the particle size of the thermal energy storage material is selected from the range 0.5 mm to 10 mm.

In another form, the particle size of the thermal energy storage material is selected from the range 0.5 mm to 4 mm.

In another form, the composite thermal member is capable of operating at temperatures of from about 600° C. to about 1,400° C. in an oxidising atmosphere.

In another form, the composite thermal member is capable of operating at temperatures of from about 1,000° C. to about 1,400° C. in an oxidising atmosphere.

In a second aspect, the present disclosure provides a method for forming a composite thermal member for storing thermal energy, the method comprising:
obtaining a slurry mixture comprising:
   a refractory material,
   a slurry forming liquid,
   a binder material,
   a protective layer material, and
   a thermal energy storage material;
moulding the slurry mixture to form an unprocessed moulded composite thermal member;
processing the unprocessed moulded composite thermal member to form the composite thermal member, wherein the processing comprises causing the protective layer material to form an outer protective layer surrounding the composite thermal member.

In another form, processing the unprocessed composite thermal member comprises:
curing the unprocessed moulded composite thermal member to form a cured part-processed composite thermal member; and
heating the cured part-processed composite thermal member to cause the refractory material to react with the protective layer material to form an outer protective layer around the cured part-processed composite thermal member to form the composite thermal member.

In another form, heating the cured part-processed composite thermal member comprises:
a first heating stage to remove residual slurry forming liquid in the part-processed composite thermal member; and
a second heating stage to cause the refractory material to oxidise and react with the protective layer material to form an outer protective layer and for refractory bond formation.

In another form, the refractory material comprises silicon carbide.

In another form, the silicon carbide is selected from one or more of the group consisting of nitride-bonded silicon carbide, silicon-oxy-nitride bonded silicon carbide, clay bonded silicon carbide, sialon bonded silicon carbide, and β-SiC bonded silicon carbide.

In another form, the silicon carbide is nitride-bonded silicon carbide.

In another form, the slurry forming liquid comprises water.

In another form, the binder material is a cement material.

In another form, the cement material is calcium aluminate cement.

In another form, the protective layer material is a glass forming material capable of forming a glassy outer protective layer around the composite thermal member.

In another form, the glass forming material is an alkali material selected from one or more of the group consisting of calcium aluminate, calcium carbonate, magnesium carbonate, sodium carbonate, calcium oxide, magnesium oxide, aluminium oxide, boron trioxide, alumina, sodium silicate or potassium silicate.

In another form, the glass forming material is calcium aluminate.

In another form, the thermal energy storage material is a phase change material.

In another form, the phase change material is a silicon based eutectic material.

In another form, the phase change material is Aluminium-Silicon-Nickel (Al—Si—Ni) eutectic.

In another form, the thermal energy storage material is in particulate or granular form having a predetermined size range.

In another form, the particle size of the thermal energy storage material is selected from the range 0.5 mm to 10 mm.

In another form, the particle size of the thermal energy storage material is selected from the range 0.5 mm to 4 mm.

In another form, a weight ratio of the combination of refractory material, binder material and protective layer material to thermal energy storage material is 1:1.

In another form, the amount of refractory material in the slurry mixture is from about 40 wt % to about 99 wt %.

In another form, the amount of binder material in the slurry mixture is from about 1 wt % to about 40 wt %.

In another form, the amount of protective layer material in the slurry mixture is from about 0 wt % to about 20 wt %.

In another form, the amount of thermal energy storage material in the slurry mixture is from about 10 wt % to about 60 wt %.

In another form, the amount of slurry forming liquid in the slurry mixture is from about 4 mL to about 20 mL of liquid per 100 g of the combination of refractory material, binder material, protective layer material and thermal energy storage material.

In another form, the slurry mixture is cast into a mould having a desired shape of the composite thermal member.

In another form, the slurry mixture is pressed into a mould having a desired shape of the composite thermal member using a pressing die.

In another form, the cured part-processed composite thermal member is heated to a first predetermined temperature of from about 600° C. to about 1000° C.

In another form, the first predetermined temperature is about 800° C.

In another form, the cured part-processed composite thermal member is further heated to a second predetermined temperature of from about 1200° C. to about 1600° C.

In another form, the second predetermined temperature is about 1400° C.

In another form, the cured part-processed composite thermal member is heated to a predetermined temperature of from about 1200° C. to about 1600° C.

In another form, the second predetermined temperature is about 1400° C.

In another form, the cured part-processed composite thermal member is heated at a heating rate of from about 5° C. per hour to about 50° C. per hour.

In another form, the composite thermal member is able to operate at temperatures of from about 1,000° C. to about 1,400° C. in an oxidising atmosphere.

In a third aspect, the present disclosure provides a composite structural member formed in accordance with the second aspect of the disclosure.

In a fourth aspect, the present disclosure provides for use of a composite thermal member in accordance with first or third aspects for storing thermal energy.

### BRIEF DESCRIPTION OF DRAWINGS

Embodiments of the present disclosure will be discussed with reference to the accompanying drawings wherein:

FIG. 1 is a flowchart of a method for forming a composite thermal member in accordance with an illustrative embodiment;

FIG. 2 is a figurative view showing the components for producing a slurry mixture in accordance with an illustrative embodiment; and

FIG. 3 is a flowchart of a method for processing the unprocessed moulded composite thermal member to form the composite thermal member in accordance with an illustrative embodiment.

In the following description, like reference characters designate like or corresponding parts throughout the figures.

### DESCRIPTION OF EMBODIMENTS

As used herein, the term “about” means plus or minus 5% from a specified amount. For example, “about 10” refers to 9.5 to 10.5. A ratio of “about 5:1” refers to a ratio from 4.75:1 to 5.25:1.

Referring now to FIG. 1, there is shown a method 100 for forming a composite thermal member. In one example, the composite thermal member is capable of operating at temperatures from about 600° C. to about 1,400° C. in an oxidising atmosphere. In another example, the composite thermal member is capable of operating at temperatures of from about 1,000° C. to about 1,400° C. in an oxidising atmosphere.

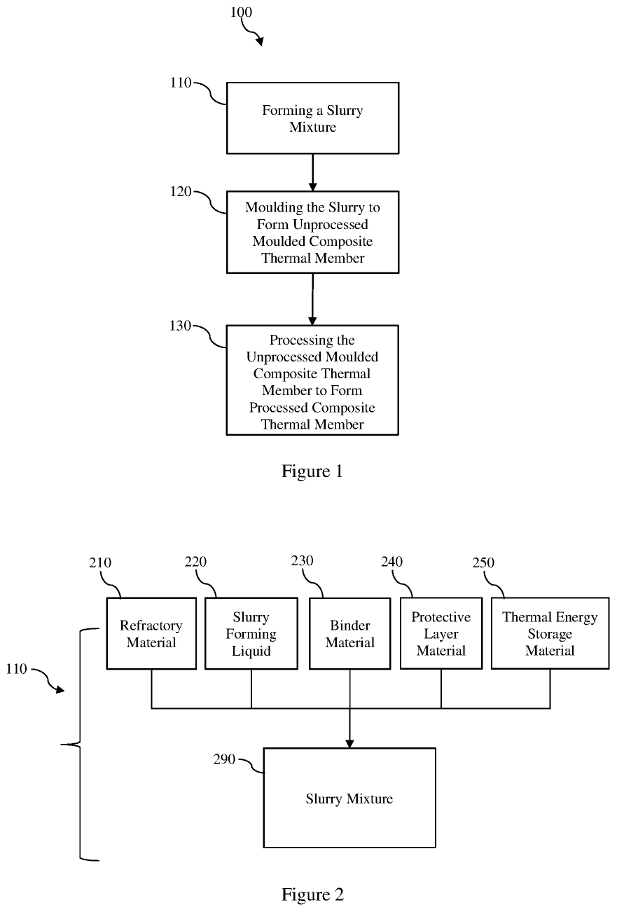

Referring also to FIG. 2, at step 110 a slurry mixture 290 is produced comprising a refractory material 210, a slurry forming liquid 220, a binder material 230, a protective layer material 240 and a thermal energy storage material 250.

In certain embodiments, the refractory material 210 comprises silicon carbide. The silicon carbide may be pure silicon carbide, recrystallized silicon carbide or it may be particulate silicon carbide in a dissimilar bonding matrix. A range of bonding matrices or bond phases are known in the art and can be used. Bonded silicon carbides that may be used include nitride-bonded silicon carbide, silicon-oxy-nitride bonded silicon carbide, clay bonded silicon carbide, sialon bonded silicon carbide, and β-SiC bonded silicon carbide. In another example, the refractory material 210 comprises carbon. In another example, the refractory material 210 comprises zirconia. In another example, the refractory material 210 comprises chromite. In another example, the refractory material 210 comprises clay. In another example, the refractory material 210 comprises silica sand, silica or fumed silica. In another example, the refractory material 210 comprises magnesia. The refractory material 210 may also be a combination of any of the aforementioned materials.

In certain embodiments, the slurry forming liquid 220 is water or an aqueous composition. Potable water is typically suitable. The slurry forming liquid may also contain one or more additives including pH adjusting agents, acids, bases, surfactants, thixotropic agents, and dispersants. Certain additives may be used depending on the silicon carbide bonding system used, and suitable additives for this purpose include phosphoric acid.

In certain embodiments, the binder material 230 is a cement material. A wide range of binder materials are known in the art and may be suitable for use, including calcium aluminate cement, strontium aluminate cement, hydratable alumina, colloidal silica, silica sol, sodium silicate, potassium silicate, aluminium phosphate, and phosphoric acid.

In certain embodiments, the protective layer material 240 is a high temperature glass forming material which will form an outer protective layer around the composite thermal member. In certain embodiments, the high temperature glass forming material is an alkali material such as calcium aluminate, calcium carbonate, magnesium carbonate, sodium carbonate, calcium oxide, magnesium oxide, aluminium oxide, boron trioxide, alumina, sodium silicate or potassium silicate.

In certain embodiments, the thermal energy storage material 250 is a phase change material. In some embodiments, the phase change material is elemental silicon. In other embodiments, the phase change material is a eutectic material.

For example, the eutectic material may be a silicon based eutectic material. The silicon based eutectic material may be a binary alloy comprising silicon and any one of aluminium, nickel, iron, copper, manganese, boron, chromium, cobalt, hafnium, molybdenum, niobium, rhenium, tantalum, titanium, tungsten, vanadium, and zirconium. Alternatively, or in addition, the silicon based eutectic material may be a ternary alloy comprising silicon and any two of aluminium, nickel, iron, copper, manganese, boron, chromium, cobalt, hafnium, molybdenum, niobium, rhenium, tantalum, titanium, tungsten, vanadium, and zirconium. Alternatively still, the silicon based eutectic material may be a higher order alloy comprising silicon and any three or more of aluminium, nickel, iron, copper, manganese, boron, chromium, cobalt, hafnium, molybdenum, niobium, rhenium, tantalum, titanium, tungsten, vanadium, and zirconium. The silicon based eutectic material may comprise at least about 30 at. % Si, at least about 40 at. % Si, at least about 50 at. % Si, at least about 60 at. % Si, at least about 70 at. % Si, at least about 80 at. % Si, or at least about 90 at. % Si. Some specific examples of silicon based eutectic materials include, but are not limited to:
Aluminium-Silicon-Nickel (Al—Si—Ni) eutectic having a melting point of approximately 1079° C.;
Iron-Silicon (Fe—Si) eutectic comprising in one example of 50% silicon and having a corresponding melting point of approximately 1202° C.;
Copper-Silicon (Cu—Si) eutectic comprising in one example of 45% silicon and having a melting point of approximately 800° C.-900° C.

Some silicon based eutectic materials have similar energy storage capacity by volume to elemental silicon; however, they have a lower melting point and additionally the expansion effects on solidification resulting from the presence of silicon may be reduced depending on the exact composition of the eutectic.

In certain embodiments, the phase change material is a eutectic material that forms a relatively stable oxide when heated in oxygen. As an example, Al—Si—Ni eutectic, which does not expand on solidification, can form a relatively stable oxide layer which for a period of time will prevent the initial diffusion of oxygen through to the underlying material although this protective layer cannot be relied on for long term use in an open air environment.

In certain embodiments, the thermal energy storage material is provided in particulate or granular form where the average particle size ranges up to 25 mm. As would be appreciated, the thermal energy storage material can be crushed or ground to a selected size adopting standard crushing or grinding techniques.

In certain specific embodiments, the grain size of the thermal energy storage material is selected from the range 0.5 mm to 4 mm. In other specific embodiments, the particle size is selected from the range 0.5 mm to 10 mm. As a general observation, the selection of a larger particle size for a given amount of thermal energy storage material will result in less oxidation of the thermal energy storage material due to the reduced surface area available for oxidation; however, the particle size must be balanced with the requirements of the slurry mixture as will be discussed below.

In certain embodiments, the thermal energy storage material is a phase change material comprising Al—Si—Ni eutectic in granular form having a grain size ranging from 0.5 mm to 4 mm. In these embodiments, the preferred weight ratio of the combination of refractory material, binder material and protective layer material to thermal energy storage material is 1:1. This ratio results in 30% to 40% volume of phase change material in the finally formed composite thermal member with the exact volume proportion being dependent on the density of the thermal energy storage material.

If desired, the slurry mixture may further comprise one or more additives that confers a desired property on the slurry mixture and/or the composite thermal member. Suitable additives that may be used include wetting agents, surfactants, flocculants, viscosity modifying agents, thixotropic agents, set retardants, set accelerants, plasticisers, corrosion inhibitors, shrinkage reducing agents, and the like.

In certain embodiments, the slurry mixture is formed by combining the refractory material, binder material, protective layer material, thermal energy storage material and the slurry forming liquid and mixing. The components of the slurry mixture can be mixed using a suitable mixer, such as a paddle mixer, a “milk-shaker” mixer, a rotating drum, and the like. The amount of refractory material in the slurry mixture may be from about 40 wt % to about 99 wt %. The amount of binder material in the slurry mixture may be from about 1 wt % to about 40 wt %. The amount of protective layer material in the slurry mixture may be from about 0 wt % to about 20 wt %. It will be appreciated that in embodiments in which the protective layer material and the binder material are the same then the amount of additional protective layer material can be 0 wt %. However, when the protective layer material and the binder material are different, the amount of protective layer material in the slurry mixture may be from about 2 wt % to about 20 wt %. The amount of thermal energy storage material in the slurry mixture may be from about 10 wt % to about 60 wt %. The amount of slurry forming liquid (e.g. water) may be from about 4 mL to about 20 mL of water per 100 g of the combination of refractory material, binder material, protective layer material and thermal energy storage material. As would be appreciated, the viscosity of the slurry mixture may be modified by varying the type or amount of slurry forming liquid that is used and/or by incorporating a thixotropic agent to obtain a desired viscosity.

At step 120, the slurry mixture is moulded into a desired shape and configuration using a moulding arrangement to form an unprocessed moulded composite thermal member. In one example, the slurry mixture is cast into a mould having the desired shape of the composite thermal member. As would be appreciated, the unprocessed moulded composite thermal member and the eventual formed composite thermal member may be made in this embodiment to have the configuration or shape of any mould into which the slurry mixture may be cast into.

In another example, the slurry mixture is moulded into a desired shape and configuration using a mould pressing arrangement comprising a mould and a pressing die which functions to compress the slurry into the shape of the mould in the process eliminating at least some of the water from the slurry. In one example, the mould pressing arrangement is automated.

In another example, moulding the slurry mixture may comprise hand tamping or forming the unprocessed moulded composite thermal member. In another embodiment, moulding the slurry mixture may involve using a slip casting arrangement for forming hollow members, tiles or plates.

As would be appreciated, for a casting process the slurry mixture will have a lower viscosity corresponding to a higher slurry forming liquid content as compared to a pressing process where the slurry mixture will have a higher viscosity. Advantageously, the moulding process is a room temperature process which significantly reduces manufacturing complexity and cost when compared to high temperature manufacturing processes.

Configurations or shapes that the composite thermal member may be formed into include, but are not limited to, rectangular prism or “brick”, cylindrical, general prism, triangular or trapezoidal shaped prism, spherical, polygonal volume or non-regular. Furthermore, the composite thermal member may be formed to include channels, interlocking regions, support surfaces or undulating surfaces such as ribs or nodules as required to assist in heat transfer or to provide structural reinforcement. Additionally, the composite thermal member may be formed in an annulus or donut configuration or having a hollow section as required.

In one example, the mould is in the shape of a rectangular prism, or ‘brick’, with dimensions: 230 mm×115 mm×75 mm to form a corresponding brick shaped composite thermal member.

Referring back to FIG. 1, at step 130, the unprocessed moulded composite thermal member is then processed to form the composite thermal member.

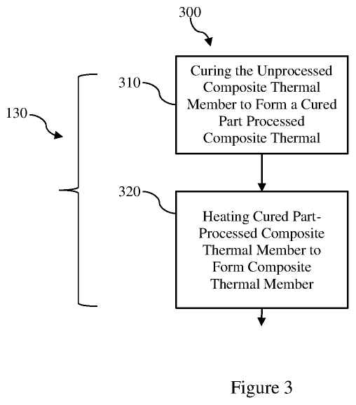

Referring now to FIG. 3, there is shown a flowchart 300 for processing the unprocessed moulded composite thermal member to form the composite thermal member according to an illustrative embodiment and in accordance with step 130 of FIG. 1.

At step 310, the unprocessed moulded composite thermal member is cured to form a cured part-processed composite thermal member. In one example, the unprocessed moulded composite thermal member is allowed to cure for a period of 24-48 hours at room temperature which allows the binder material in the slurry mixture to set. In the example where a moulding arrangement has been used, the cured part-processed composite thermal member may be removed from the mould. As would be appreciated, the exact period of curing may be modified depending on the slurry mixture and/or the ambient conditions in which the curing is carried out. For example, the type and amount of binder material used may be taken into consideration in determining the curing period. As would be appreciated, the binder material is hydrated in the curing step and, therefore, the curing period should be sufficient to at least allow the binder material to become substantially hydrated. The person skilled in the art is able to determine the curing period by considering the amount and type of binder material and using existing knowledge of hydration times for different materials. The person skilled in the art also understands that the hydration reaction is exothermic and, in the case where higher proportions of binder material are used, the composite thermal member can generate enough heat to evaporate some of the water before the binder material can hydrate sufficiently and this needs to be taken into account when determining the most appropriate curing conditions. For example, this can present a problem when casting on a hot day. If desired, the level, degree or extent of curing can be determined using any method that is known for this purpose in the art. For example, the ‘Ring test’ may be used to check the extent of curing whereby the cured part-processed composite thermal member is hit with a small hammer and the tone changes from dull to bright as the thermal member cures. Following this curing process 310, the cured part-processed composite thermal member will generally have enough structural integrity to allow handling and transporting as required.

At step 320, the cured part-processed composite thermal member is heated to cause the protective layer material 240 which is a glass layer forming material to react and form an outer protective layer around the cured part-processed composite thermal member to form the final composite thermal member.

In one example that is especially suitable for heating cured part-processed composite thermal members that have been produced on a relatively large scale, the heating process comprises a first heating stage where the temperature is gradually elevated to a first predetermined temperature to remove the residual water present in the cured part-processed composite thermal member after the ceramic bonds have formed which releases more water. Following the first heating stage, the cured part-processed composite thermal member then undergoes a second heating stage where the composite thermal member is heated at a faster rate to a second predetermined temperature or protective layer forming temperature causing the glass layer forming material to form an outer protective glass layer that surrounds or envelops the composite thermal member. The first predetermined temperature may be from about 600° C. to about 1000° C., such as about 600° C., 610° C., 620° C., 630° C., 640° C., 650° C., 660° C., 670° C., 680° C., 690° C., 700° C., 710° C., 720° C., 730° C., 740° C., 750° C., 760° C., 770° C., 780° C., 790° C., 800° C., 810° C., 820° C., 830° C., 840° C., 850° C., 860° C., 870° C., 880° C., 890° C., 900° C., 910° C., 920° C., 930° C., 940° C., 950° C., 960° C., 970° C., 980° C., 990° C. or 1000° C. In certain embodiments, the first predetermined temperature is about 800° C. The part-processed composite thermal member may be maintained at the first predetermined temperature for a period of from about 0 hours to about 24 hours.

The second predetermined temperature may be from about 1200° C. to about 1600° C., such as about 1200° C., 1210° C., 1220° C., 1230° C., 1240° C., 1250° C., 1260° C., 1270° C., 1280° C., 1290° C., 1300° C., 1310° C., 1320° C., 1330° C., 1340° C., 1350° C., 1360° C., 1370° C., 1380° C., 1390° C., 1400° C., 1410° C., 1420° C., 1430° C., 1440° C., 1450° C., 1460° C., 1470° C., 1480° C., 1490° C., 1500° C., 1510° C., 1520° C., 1530° C., 1540° C., 1550° C., 1560° C., 1570° C., 1580° C., 1590° C. or 1600° C. In certain embodiments, the second predetermined temperature is about 1400° C. The part-processed composite thermal member may be maintained at the second predetermined temperature for a period of from about 12 hours to about 24 hours.

In another example that may be more suitable for heating cured part-processed composite thermal members that have been produced on a relatively small scale, the first heating stage referred to in the previous example may be omitted and the cured part-processed composite thermal members may be heated from ambient temperature to the second predetermined temperature at a suitable heating rate provided that the heating rate results in all residual water is removed from the cured part-processed composite thermal members as a result of the gradual temperature increases during the heating stage.

As will be appreciated, the heating stage(s) should be carried out at a heating rate that allows water to be released at a rate that avoids the formation of steam within the cured part-processed composite thermal member and/or at a rate that minimises or avoids cracking. The heating rate will depend on the materials used in the cured part-processed composite thermal member, the mass of the cured part-processed composite thermal member and/or the shape and configuration of the cured part-processed composite thermal member, but heating rates for a 230 mm×115 mm×75 mm brick shaped composite thermal member will typically be from about 5° C. per hour to about 50° C. per hour. For example, the first predetermined temperature may be about 800° C. and the heating rate used in the first heating stage may be about 25° C./hr. The second heating stage can be carried out using a heating rate that is faster than the first heating stage heating rate because the amount of water released during the second heating stage is significantly less and is less volatile. The heating rate for the second heating stage for a 230 mm×115 mm×75 mm brick shaped composite thermal member will typically be from about 5° C. per hour to about 50° C. per hour. For example, the second predetermined temperature may be about 1400° C. and the heating rate used in the second heating stage may be rate about 40° C./hr. A heating rate of from about 5° C. per hour to about 50° C. per hour may be used when separate first and second heating stages are not used (e.g. when relatively small scale composite thermal members are being produced).

As oxygen is consumed during the curing process 320, the heating of the part-processed composite thermal member should occur in an environment where there is available air flow; however, high air flow directly onto the composite thermal members is not required. As would be appreciated, the amount of air required will also depend on the number and size of composite thermal members being processed.

In this example, the outer protective layer formed around the composite thermal member protects not only the thermal member but the thermal energy storage material resident or contained within the composite structural member from oxidation at high temperatures. This allows the composite thermal member to be employed to store and release thermal energy in operating temperatures of, in one application, up of to 1,200° C.

In accordance with the present disclosure, the Applicant has also found that besides the resistance to oxidation due to the protective layer, the inherent porosity of the composite thermal member may be chosen to accommodate for the volume change of the phase change material as it transitions between different phases during heating and cooling cycles. This porosity may be modified by preferentially selecting a range of particle sizes for the phase change material. In this manner, the structural and thermal stability of the composite thermal member, as well as the resistance to oxidation, may be additionally enhanced. As a result, the likelihood that the eventual formed composite thermal member will fracture or crack when used for storing and retrieving thermal energy will be further reduced.

As would be appreciated, composite thermal members formed in accordance with the present disclosure may also function to have a structural, building or construction application such as brick members (discussed above), beam members, sheet members, wall members, floor members and strut members. In this manner, the composite thermal member not only functions to store and retrieve thermal energy but may also form part of the structure.

As would be appreciated, composite thermal members formed in accordance with the present disclosure may be used to implement thermal energy storage and retrieval systems that have a number of significant advantages over prior art systems.

In one example, composite thermal members are able to operate at high temperature (1,000° C. to 1,400° C.) in an oxidising atmosphere (eg, air or combustion products) instead of requiring an inert gas atmosphere. This capability significantly decreases system cost and simplifies maintenance of any thermal energy storage and retrieval system adopting composite thermal members to store thermal energy.

Additionally, composite structural members formed in accordance with the present disclosure can have an increased ratio of thermal energy storage material to containment space which increases the potential energy storage density and heat transfer characteristics for a given volume when compared to existing thermal energy storage and retrieval systems.

Another important benefit, is that there is significantly more flexibility to form composite thermal members in accordance with present disclosure to a desired shape so that they can be configured to match the thermodynamic and heat transfer requirements of a system, eg, heat input, heat output and storage capacity. In addition, this enhanced configurability allows a given system to be optimised for other requirements such as improved serviceability, modularity or capital cost without having to be constrained by a particular container implementation.

A further significant advantage is that because the thermal energy storage material is encapsulated within composite structural member the safety risks associated with containing large pools of molten thermal energy storage material such as silicon are eliminated. This not only improves safety but simplifies maintenance.

### EXAMPLES

### Example 1—Formation of a Composite Thermal Member Comprising Al—Si—Ni Eutectic Thermal Energy Storage Material

A slurry mixture was produced in accordance with step 110 of FIG. 1 (and also see FIG. 2) from a commercially available SiC based castable refractory material, composed of 60-90% silicon carbide and 2-25% calcium aluminate. The refractory material used contained calcium aluminate which formed the binder material and the protective layer material in the slurry mixture. Potable water slurry forming liquid and Al—Si—Ni eutectic thermal energy storage material (melting point of approximately 1079° C.) were also included in the slurry mixture. The Al—Si—Ni eutectic thermal energy storage material was in particulate form having a particle size ranging from 0.5 mm to 4 mm. In this embodiment, the protective layer material is the same as the binder material, ie, calcium aluminate, and functions as a glass layer forming material. The components of the slurry mixture were combined and mixed for a period of 5 minutes to obtain the slurry mixture. The mixing time depends at least in part on the amount and type of binder material used and mixing needs to occur for a time that is sufficient for the binder material as well as any wetting agents and flocculants in the mixture to be hydrated.

The slurry mixture was then formed into unprocessed moulded composite thermal members in the form of bricks by being poured into respective 230 mm×115 mm×75 mm moulds in accordance with step 120 of FIG. 1.

In accordance with step 130 of FIG. 1, these unprocessed moulded composite thermal members were then allowed to cure for a period of 24-48 hours to form a cured part-processed thermal brick (see also step 310 of FIG. 3). The cured part-processed moulded composite thermal members were then heated in excess air to a temperature of 800° C. at a rate of 25° C./hr and then to 1400° C. at a rate of 40° C./hr, after which the composite thermal member was obtained.

Without intending to be bound by any specific theory, it is thought that in this second heating stage, the refractory material in the form of silicon carbide reacts with the calcium aluminate by first passively oxidising to form silicon dioxide (SiC+1.5O₂→SiO₂+CO). The silicon dioxide then reacts with the calcium aluminate to form the outer protective glass layer (SiO₂+CaO·Al₂O₃→CaO·Al₂O₃·SiO₂). In this manner, and in accordance with the present disclosure, a relatively low melting point glass forms on the surfaces of the cured part-processed composite thermal member that are exposed to air (e.g. the outer surfaces) to form a protective layer that surrounds or envelops the composite thermal member upon cooling of the composite thermal member.

The resulting composite thermal member may then be used to store and retrieve thermal energy in operation temperatures of 1400° C., i.e., below the temperature at which the glassy protective layer will flow or degrade, as it will be protected from oxidation due to the protective layer which both protects the composite thermal member and the contained thermal energy storage material.

### Example 2—Formation of a Composite Thermal Member Comprising Al—Si—Ni Eutectic Thermal Energy Storage Material

In a prophetic example, a refractory material consisting of silicon carbide in the size range of 0.5-10 microns and silicon in the size range of 0.5-5 microns could be combined in a ratio of 1:1. This mixture could then be combined with a thermal energy storage material (either silicon or a silicon-based eutectic material such as Al—Si—Ni, Fe—Si, Cu—Si, Mn—Si, B—Si or Cr—Si) in the size range of 0.5-4 mm in a ratio of 1:1, along with a slurry forming mixture consisting of de-ionised water and ammonium hydroxide to maintain a pH of 8.5-9. A binder material, consisting of magnesium lignosulphonate (1-5 wt. %) and a protective layer material consisting of calcium aluminate (1-5 wt. %) and sodium silicate (1-5 wt. %) could then be added. All materials could be mixed and cast into a plaster mould and allowed to cure to form a cured part-processed composite thermal member. The cured composite thermal member could then be heated to 1400° C. in a nitrogen atmosphere and held for 2 hours before increasing temperature to 1450° C. and holding for a further 2 hours. This process is expected to convert the silicon in the refractory material to silicon-nitride which acts as a binder. The cured part-processed composite thermal member could then again be heated to 1400° C. in excess air to form a composite thermal member having a protective glassy layer.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A composite thermal member for storing thermal energy comprising:
a refractory material,
a binder material,
a thermal energy storage material, wherein the thermal energy storage material is a phase change material comprising a metallic alloy, the metallic alloy comprising silicon and one or more of aluminium, nickel, iron, copper, manganese, boron, chromium, cobalt, hafnium, molybdenum, niobium, rhenium, tantalum, titanium, tungsten, vanadium, and zirconium; and
an outer protective layer.

2. The composite thermal member of claim 1, wherein the refractory material comprises silicon carbide.

3. The composite thermal member of claim 2, wherein the silicon carbide forms cement bonded silicon carbide, nitride-bonded silicon carbide, silicon-oxy-nitride bonded silicon carbide, clay bonded silicon carbide, sialon bonded silicon carbide or β-SiC bonded silicon carbide in the composite thermal member.

4. The composite thermal member of claim 1, wherein the binder material is a cement material.

5. The composite thermal member of claim 4, wherein the cement material is calcium aluminate cement.

6. The composite thermal member of claim 1, wherein the outer protective layer is a glassy outer protective layer.

7. The composite thermal member of claim 6, wherein the glassy outer protective layer is formed from an alkali material selected from one or more of the group consisting of calcium aluminate, calcium carbonate, magnesium carbonate, sodium carbonate, calcium oxide, magnesium oxide, aluminium oxide, boron trioxide, alumina, sodium silicate or potassium silicate.

8. The composite thermal member of claim 7, wherein the outer protective layer is formed from calcium aluminate.

9. The composite thermal member of claim 1, wherein the metallic alloy is a eutectic alloy.

10. The composite thermal member of claim 9, wherein the eutectic alloy is a binary alloy comprising silicon and any one of aluminium, nickel, iron, copper, manganese, boron, chromium, cobalt, hafnium, molybdenum, niobium, rhenium, tantalum, titanium, tungsten, vanadium, and zirconium.

11. The composite thermal member of claim 9, wherein the eutectic alloy is a ternary alloy comprising silicon and any two of aluminium, nickel, iron, copper, manganese, boron, chromium, cobalt, hafnium, molybdenum, niobium, rhenium, tantalum, titanium, tungsten, vanadium, and zirconium.

12. (canceled)

13. The composite thermal member of claim 1, wherein the thermal energy storage material is in particulate or granular form having a predetermined size range.

14.-17. (canceled)

18. A method for forming a composite thermal member for storing thermal energy, the method comprising:
obtaining a slurry mixture comprising:
a refractory material,
a slurry forming liquid,
a binder material,
a protective layer material, and
a thermal energy storage material, wherein the thermal energy storage material is a phase change material comprising a metallic alloy, the metallic alloy comprising silicon and one or more of aluminium, nickel, iron, copper, manganese, boron, chromium, cobalt, hafnium, molybdenum, niobium, rhenium, tantalum, titanium, tungsten, vanadium, and zirconium;
moulding the slurry mixture to form an unprocessed moulded composite thermal member;
processing the unprocessed moulded composite thermal member to form the composite thermal member, wherein the processing comprises causing the protective layer material to form an outer protective layer surrounding the composite thermal member.

19. The method for forming the composite thermal member according to claim 18, wherein processing the unprocessed composite thermal member comprises:
curing the unprocessed moulded composite thermal member to form a cured part-processed composite thermal member; and
heating the cured part-processed composite thermal member to cause the refractory material to react with the protective layer material to form an outer protective layer around the cured part-processed composite thermal member to form the composite thermal member.

20. The method for forming the composite thermal member according to claim 18, wherein heating the cured part-processed composite thermal member comprises:
a first heating stage to remove residual slurry forming liquid in the part-processed composite thermal member; and
a second heating stage to cause the refractory material to oxidise and react with the protective layer material to form an outer protective layer and for refractory bond formation.

21. The method of claim 18, wherein the refractory material comprises silicon carbide.

22. The method of claim 21, wherein the silicon carbide is selected from one or more of the group consisting of nitride-bonded silicon carbide, silicon-oxy-nitride bonded silicon carbide, clay bonded silicon carbide, sialon bonded silicon carbide, and β-SiC bonded silicon carbide.

23. The method of claim 22, wherein the silicon carbide is nitride-bonded silicon carbide.

24. The method of claim 18, wherein the slurry forming liquid comprises water.

25. The method of claim 18, wherein the binder material is a cement material.

26. The method of claim 25, wherein the cement material is calcium aluminate cement.

27. The method of claim 18, wherein the protective layer material is a glass forming material capable of forming a glassy outer protective layer around the composite thermal member.

28. The method of claim 27, wherein the glass forming material is an alkali material selected from one or more of the group consisting of calcium aluminate, calcium carbonate, magnesium carbonate, sodium carbonate, calcium oxide, magnesium oxide, aluminium oxide, boron trioxide, alumina, sodium silicate or potassium silicate.

29. The method of claim 28, wherein the glass forming material is calcium aluminate.

30. The method of claim 18, wherein the metallic alloy is a eutectic alloy.

31. The method of claim 30, wherein the eutectic alloy is a binary alloy comprising silicon and any one of aluminium, nickel, iron, copper, manganese, boron, chromium, cobalt, hafnium, molybdenum, niobium, rhenium, tantalum, titanium, tungsten, vanadium, and zirconium.

32. The method of claim 30, wherein the eutectic alloy is a ternary alloy comprising silicon and any two of aluminium, nickel, iron, copper, manganese, boron, chromium, cobalt, hafnium, molybdenum, niobium, rhenium, tantalum, titanium, tungsten, vanadium, and zirconium.

33. (canceled)

34. The method of claim 18, wherein the thermal energy storage material is in particulate or granular form having a predetermined size range.

35.-44. (canceled)

45. The method of claim 19, wherein the cured part-processed composite thermal member is heated to a first predetermined temperature of from about 600° C. to about 1000° C.

46. (canceled)

47. The method of claim 45, wherein the cured part-processed composite thermal member is further heated to a second predetermined temperature of from about 1200° C. to about 1600° C.

48.-52. (canceled)
